(19) United States
(12) Patent Application Publication
(10) Pub. No.: US 2005/0115507 A1
(43) Pub. Date: Jun. 2, 2005

(54) Identification of small ruminants

(75) Inventors: Ilan Halachmi, Kfar Yehoshua (IL); Eithan Uner, Kibbutz Afikim (IL); Zafrir Pinski, Kibbutz Afikim (IL); Ronny Andrei, Tiberias (IL); Ran Malamud, Ramat Tsvi (IL); Zvi Keren, Sde-Ilan (IL)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: S. A. E. Afikim Computerized Dairy Management System, Kibbutz Afikim (IL)

(21) Appl. No.: 10/500,788

(22) PCT Filed: Jan. 14, 2003
(86) PCT No.: PCT/IL03/00034

Related U.S. Application Data
(60) Provisional application No. 60/356,327, filed on Jan. 15, 2002.

(51) Int. Cl. A01J 3/00

(52) U.S. Cl. 119/14.14

(57) ABSTRACT

A system for identifying a ruminant, which is being milked. The system includes a transmitter attached to a hind leg of the ruminant and the transmitter transmits a predefined signal, which identifies the ruminant to which the transmitter is attached. The system includes at least one teat cup on which is attached an antenna to receive the signal with which to identify the animal. The teat cup is positionable on the ruminant's teat. A method for using the system is taught as is a teat cup having an antenna fixed thereon.

### FIELD OF THE INVENTION

The present invention relates to a system, teat cup and method for identifying a small ruminant being milked.

### BACKGROUND OF THE INVENTION

The use of transponders or other transmitters to locate and/or identify animals is well known. More particularly the use of transponders in identifying individual cows during a milking operation has been much discussed in the dairy farm management literature and has been widely employed. Cows may be identified by attaching transmitters to collars or, alternatively, encasing transponders in ear tags, which are attached to cartilaginous tissue of the ear. Suitable receivers can be fixed in a milking stall to read the identification data signals of a cow as it enters the stall or as it is being milked. Such identification systems are described or illustrated inter alia in U.S. Pat. No. 5,996,529 (Sissom et al), U.S. Pat. No. 6,279,507 (van der Lely et al), U.S. Pat. No. 6,394,028 (Birk) and U.S. Pat. No. 6,445,296 (Sadler).

Identification methods are necessary in dairy farm management because accurately measuring and recording the productivity of individual cows within a herd is important. Known systems identify a cow being milked and measure the amount of milk that the cow produces. The systems record that data, typically through microprocessors, so that the data may later be analyzed.

Prior art ID systems generally include an ID transponder mounted on or in a neckband or collar worn by the cow. Prior art transponders are either active (battery operated), or passively activated by an antenna. The ID transponders interact with an antenna, typically one mounted on or at the door of the milking stall. As the cow passes through the stall door, the antenna, in communication with a controller, senses the ID transponder. Identification data transmitted by the tag identifies the cow. Typically, each stall also includes a milk meter to measure the milk obtained from the cow. The controller associates the data from each milk meter with a particular cow based on the ID data transmitted. Instead of an ID transponder mounted on a neck collar, other prior art identification systems use a transponder mounted on a leg band typically located immediately above the hoof.

Generally, prior art identification systems are adequate for large ruminants, such as cows. Because cows are large animals and the milking stalls are far enough away from each other, transmitted identification data signals related to a particular bovine can be read without interference from the signals of other animals in the milking area at the same time. For smaller ruminants, typically, but without being limiting, goats and sheep, such interference can be problematic. Additionally, in order to reliably detect the tags, which may be at varying distances from the antennas, the frequency needs to be relatively high. Often, however, FCC regulations prohibit use of sufficiently high frequencies.

Smaller ruminants, such as sheep and goats, are not generally milked in individual stalls. They are crowded together, more or less one next to another, during the milking operation. Signals from identification transponders of the closely positioned animals may interfere with each other, making identification of individual animals difficult. Accordingly, a system that can identify small ruminants when they are being milked is desired.

### SUMMARY OF THE PRESENT INVENTION

It is an object of the present invention to provide an identification system, device and method for small ruminants, which can be used for identifying individual animals as they are being milked.

It is a further object of the invention to provide a system for identifying a particular animal from within a closely spaced group of animals, these animals having some mobility during a milking operation.

It is an object of the present invention to provide a teat cup having a receiving antenna substantially at the height of an identification data transmitter attached to small ruminants.

It is yet another object of the present invention to provide a method for identifying small ruminants having some mobility during a milking operation.

According to one aspect of the present invention, there is provided a system for identifying a ruminant being milked. The system includes a transmitter attached to a hind part of the ruminant, which transmits a predefined signal identifying the ruminant to which the transmitter is attached. The system also includes one or more teat cups positionable on a teat of the ruminant being milked and having an antenna affixed thereto. The antenna operates to receive the predefined signal and to provide the signal via a receiver device to a processor for interpreting the predefined signal thereby identifying the ruminant being milked.

In an embodiment of the present invention the transmitter is adapted for attachment to a hind leg of the ruminant. In some embodiments the transmitter is attachable to the hind leg by a strap, sometimes an elastic strap. In yet other embodiments the transmitter is part of a tag, the tag attachable to the hind leg. In some of these embodiments the tag is an electronic ear tag used in the dairy industry. In some embodiments, the transmitter is adapted for attachment above the hock of a hind leg of the ruminant.

In another embodiment of the system of the present invention the transmitter is a transponder. In some embodiments where the transmitter is a transponder the system further includes a stationary interrogation unit, the unit including a transmitter and a receiver.

In yet other embodiments, the transponder is attached to a hind leg of the ruminant. In some of these embodiments the transponder is attached to the hind leg by a strap, sometimes an elastic strap. In yet other embodiments, the transponder is part of a tag, the tag attachable to the hind leg. In some of these the tag is an electronic ear tag used in the dairy industry. In some embodiments, the transponder is adapted for attachment above the hock of a hind leg of the ruminant.

In yet another aspect of the present invention there is provided a teat cup for positioning on a teat of a ruminant during milking. The teat cup includes a flow-through vessel for collecting milk from the ruminant. The teat cup also includes an antenna affixed to the vessel to receive a signal that identifies the animal on which the teat cup is positioned.

In another embodiment of the teat cup, the cup further includes a casing for enclosing the antenna and holding it to the teat cup. In some embodiments, the casing is constructed of a flexible waterproof material. In other embodiments of the teat cup, the cup is constructed of plastic material and the antenna is encased in the plastic material during the manufacturing process of the teat cup.

In yet another aspect of the present invention there is provided a method for identifying a ruminant, the method including the steps of: attaching a means for collecting milk to a teat of a ruminant, the means for collecting milk having an antenna affixed thereto; affixing a transmitter to a hind part of the ruminant, the transmitter transmitting a predefined signal identifying the ruminant; receiving the transmitted predefined signal by the antenna; and transferring the predefined signal via a receiving device to a processor which processes the signal and identifies the ruminant on which the means for collecting milk is attached.

In yet another embodiment of the method, the affixing step is a step of affixing a transponder.

In another embodiment of the method provided by the present invention, the affixing step is effected by affixing the transmitter to a hind leg of the ruminant. In some of these embodiments the affixing step is effected by affixing the transmitter to a hind leg of the ruminant using a strap, sometimes an elastic strap.

In another embodiment of the method of the present invention, the affixing step is effected by affixing the transmitter to a hind leg of the ruminant above the hock.

In still another embodiment of the method of the present invention, the affixing step is effected by affixing the transmitter as part of a tag attachable to a hind leg of the ruminant.

### BRIEF DESCRIPTION OF THE DRAWINGS

The present invention will be understood and appreciated more fully from the following detailed description taken in conjunction with the drawings in which:

FIG. 1 is a schematic back view of a ruminant being milked using a system constructed according to an embodiment of the present invention;

FIG. 2 is a schematic lateral view of a ruminant being milked using a system constructed according to the embodiment shown in FIG. 1;

FIG. 3 is an enlarged schematic lateral view of a ruminant being milked using a system constructed according to the embodiment shown in FIGS. 1 and 2;

FIG. 4 is a schematic lateral view of a ruminant being milked using a system constructed according to a second embodiment of the present invention; and

FIGS. 5A-5D are different views of a casing used to secure an antenna to a teat cup constructed according to an embodiment of the present invention.

Similar elements in the Figures are numbered with similar reference numerals.

It will be appreciated by persons skilled in the art that the present invention is not limited by the drawings and description hereinabove presented. Rather, the invention is defined solely by the claims that follow.

### DETAILED DESCRIPTION OF PREFERRED EMBODIMENTS

The present invention teaches a system, device and method for identifying small ruminants while they are being milked. When milking small ruminants a single cluster of teat cups is used to milk several ruminants that are standing closely packed together, generally jostling one another. Each ruminant is equipped with its own transmitter which can transmit an identification data signal particular to that animal. In order to eliminate “cross-talk” from the transmitters attached to the individual animals, a short-range receiving antenna is used. The antenna must be able to identify the specific ruminant within the group being milked, even when the ruminants differ in size and move. Therefore, a fixed-position, receiving antenna common in prior art systems is generally not feasible.

The present invention teaches an antenna attached to one of the teat cups of the teat cup cluster used in the milking operation. This antenna is able to accurately identify the animal being milked when a transmitter is attached to a hind part of the animal, generally the leg. The distance between the transmitter positioned on the hind part of the animal and the receiver positioned on a teat cup attached to a teat of the animal is relatively constant, regardless of any movement by the animal. The distance is also small enough that a weak transmitter can be used. Using weak transmitters positioned on the hind part of the animal allows the antenna to pick up only the signal of the animal to which it is attached. Interfering signals from nearby animals will be effectively minimized, if not eliminated entirely.

In the discussion below, the transmitter described is a transponder, which is generally the case in the dairy industry. It should be understood that this is not intended to be limiting. Other types of transmitters known to those skilled in the art can also be used.

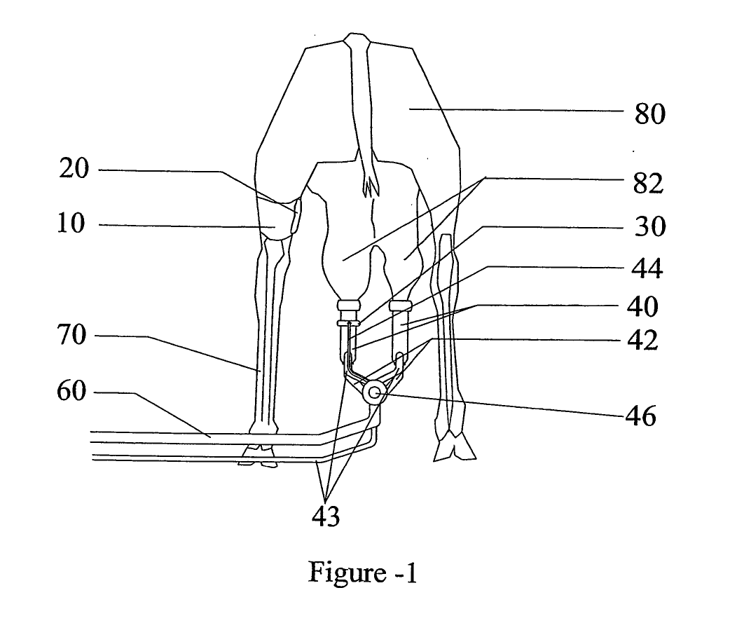

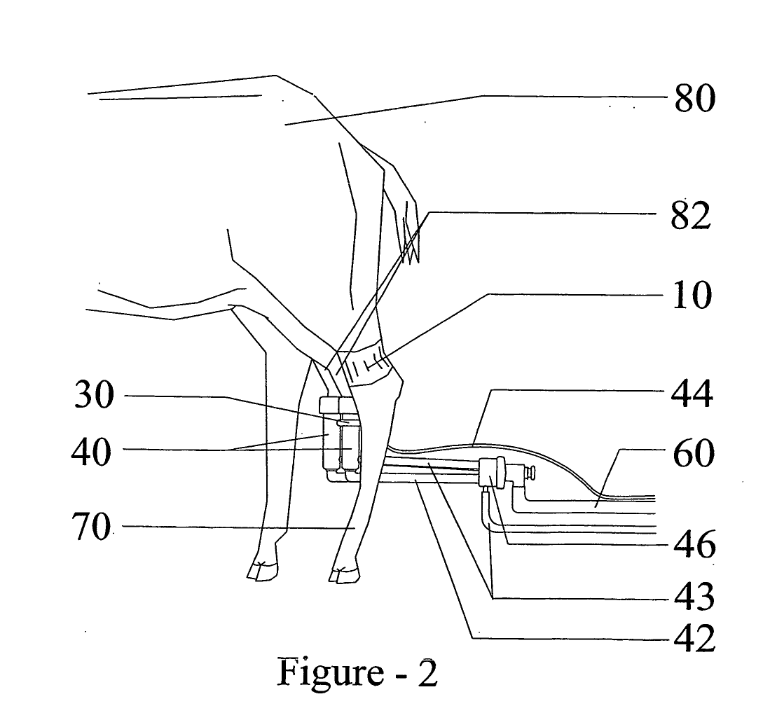

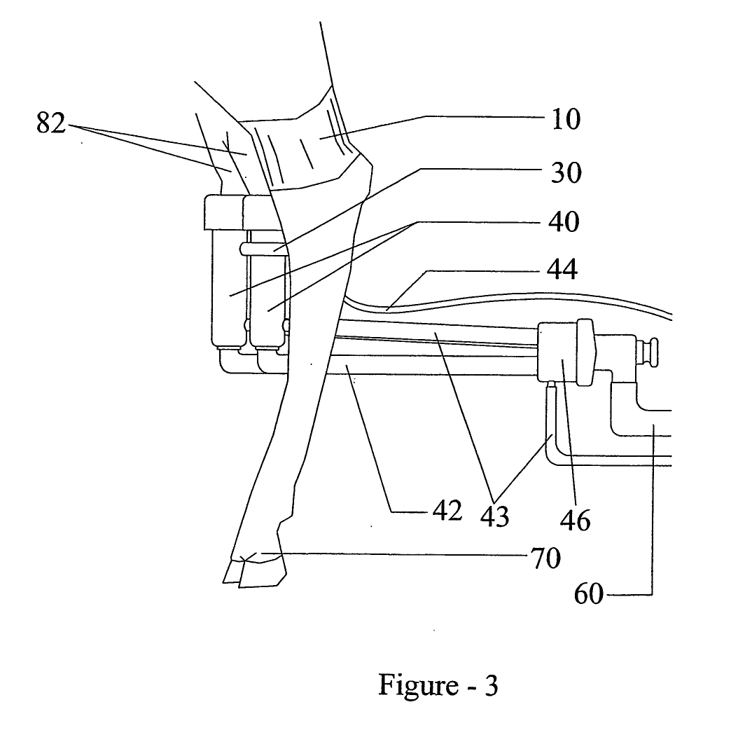

Reference is now made to FIGS. 1-3 which show various schematic views of a system for milking ruminants, particularly small ruminants, constructed according to an embodiment of the present invention. FIG. 1 is a back view of the system, FIG. 2 a lateral view of the system and FIG. 3 an expanded view of the system shown in FIG. 2. All three views will be discussed immediately hereinbelow.

A milking claw, referenced 46, having a plurality of teat cups 40 attached to the teats 82 of ruminant 80, draws milk and delivers it via conduit 60 to a milk storage container (not shown), generally via a milk meter (also not shown). Teat cups 40 attached to claw 46, are arranged so that there are conduits 42, positioned between claw 46 and teat cups 40, these conduits bringing milk from the cups to the claw. The flow of milk from teats 82 through claw 46 to the milk storage container, generally via a milk meter (both not shown), is effected by a vacuum source (also not shown). Conduit 43 extends from teat cup 40 to claw 46 and then on to a pulsator (not shown). The latter provides a pulsating vacuum to teat cup 46 via conduits 43, aiding in drawing milk from the ruminant.

Attached to teat cup 40 is an antenna 30, typically a radio frequency (RF) antenna. Positioned on a hind leg 70 of ruminant 80 is an electronic transponder 20, typically a RF transponder, which transmits predetermined identification data identifying the ruminant 80 being milked. Electronic transponder 20 is contained in a cuff or strap 10. Cuff or strap 10 can be made of any material that is easily attachable to leg 70 of ruminant 80 but hard to detach. This includes an elastic material, Velcro or any material that can maintain electronic transponder 20 in a constant position, generally at a constant height, approximately that of antenna 30 attached to teat cup 40. The strap can also be made of silicone rubber and designed to carry an identification tag. The strap can be locked to avoid inadvertent dislodgement from the leg of the ruminant. Antenna 30 is in electrical communication through a coaxial cable 44 with a transmitter/receiver in a stationary interrogation unit (not shown), controlled by a local processor (not shown), generally a microprocessor. Coaxial cable 44 is best seen in FIGS. 2 and 3. Preferably, antenna 30 is located on teat cup 40 which is positioned on the teat 82 closest to transponder 20.

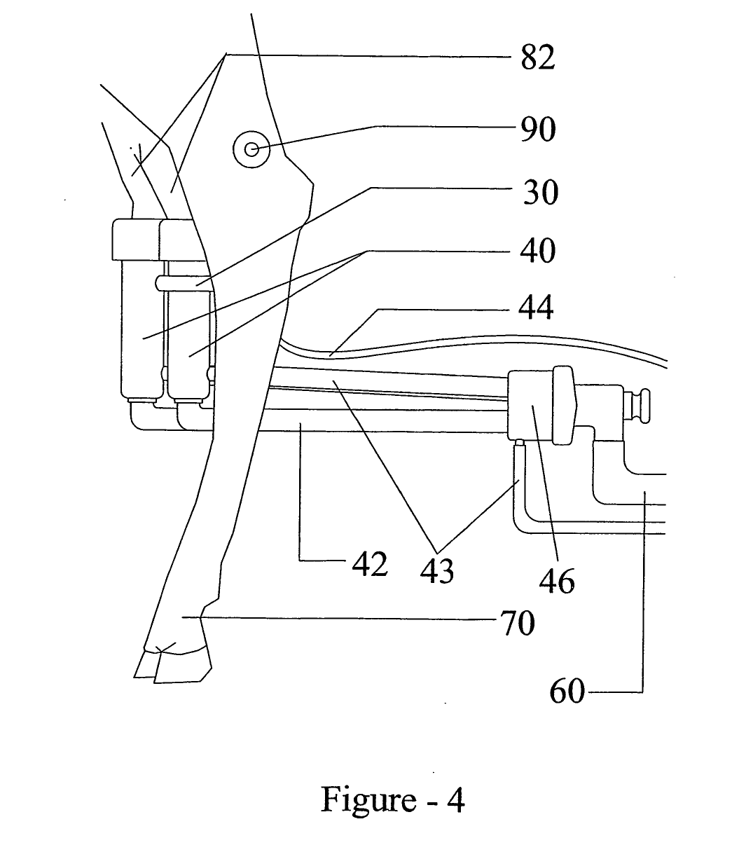

FIG. 4, to which reference is now made, is a schematic lateral view of another embodiment of the present invention. Almost all of the elements in the system are identical to those shown in FIGS. 1-3 and accordingly will not be discussed again. Only the new elements will be described.

FIG. 4 schematically illustrates a transponder positioned within ID tag 90 appended to a hind part of a ruminant 80, here a non-fleshy part of hind leg 70, generally between bones where the tag's attachment would not hurt the animal and minimizes the risk of infection. Preferably, but not exclusively, ID tag 90 may be positioned on a hind leg 70 of the animal, and even more preferably above the hock of hind leg 70 so as to minimize the distance between the transponder in ID tag 90 and receiving antenna 30. While preferably positioned on a hind leg of the ruminant because of transmission and reception considerations, in yet other embodiment tag 90 can be pinned to a fleshy part of the rump of the ruminant where pain and risk of infection to the animal are minimized. In still other embodiments, as is readily understood by one skilled in the art, the tag can be constructed as a subcutaneous implant.

Suitable ID tags which can be used in the embodiment shown in FIG. 4 may be purchased from Allflex Australia Pty Limited, Capalaba, Australia. Often such tags include a cylindrical body possessing a projection. The projection has a hole for receiving a retaining element, which holds the tag to an area of loose skin or cartilage. A transponder is housed within the tag.

In the embodiments where cuffs or straps are used the cuff or strap is constructed so as to have a transponder attached to or inserted within it. Without being limiting, and solely as an example, transponders such as the Eco-Line low frequency 23 mm glass transponder sold by Texas Instruments can be used.

Several different designs of electronic tags and RF transponders are available and can be used. Without being limiting, these include:
a passive transponder which obtains power from a stationary interrogation unit by means of an onboard inductive pickup, which also transmits an RF identification signal;
a transponder system known as full duplex, in which the tag receives its charging signal and transmits its identification signal at the same time;
a transponder system known as a half duplex where the tag receives its charging signal during one half of an operating cycle and then transmits its identification signal during the other half; and
a transponder using a built-in battery to provide the power necessary to operate it.

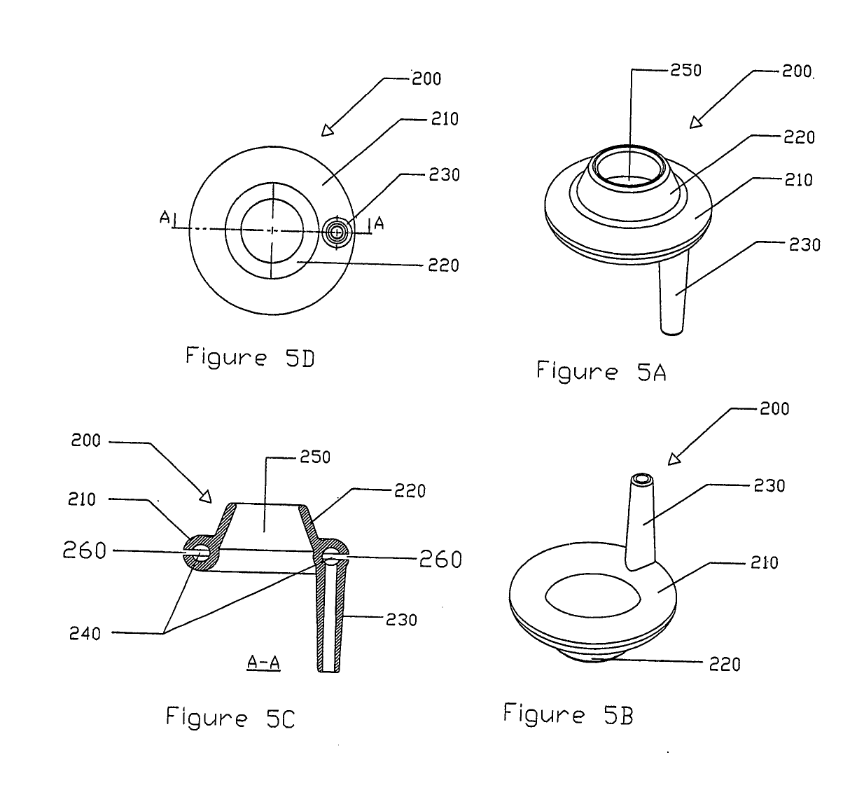

Reference is now made to FIGS. 5A-5D, which illustrate through several different views an antenna casing, which serves to affix an antenna to a teat cup according to one embodiment of the present invention. FIG. 5A is a top isometric view, FIG. 5B a bottom isometric view, FIG. 5C a lateral cross-sectional view and FIG. 5D a top view of the casing.

The casing, generally referenced as 200 and shown in FIGS. 5A-5D is a flexible, waterproof casing typically constructed of rubber or silicone rubber. The casing has a body 210 generally circular in shape from which an upwardly and inwardly tilting crown 220 extends. Body 210 is hollow as best seen in FIG. 5C and a channel 240 is located therein. Channel 240 extends around body 210 in a generally circular shape. Hollow channel 240 is constructed to receive and hold a litz wire (not shown) which serves as the antenna of the system. Channel 240 opens to the outside via a small aperture 260 through which the litz wire is inserted. Extending from body 210 is hollow outlet 230 which leads the litz wire from the antenna to coaxial cable 44 and then to a stationary interrogation unit (not shown) containing a transmitter/receiver controlled by a processor (not shown), generally a microprocessor.

Both ends of the litz wire are connected to coaxial cable 44. One end of the litz wire is connected to the middle conductor of the coaxial cable, and the other end of the wire to the shielding of the coaxial cable. Litz wire suitable for the antenna can be purchased from many suppliers including MWS Wire Industries, Westlake Village, Calif. and Wire Tronics Inc, Pine Grove, Calif.

In general, body 210, crown 220 and outlet 230 is of a unitary construction, although in some embodiments they need not be. In such cases, the three parts of casing 200 can be affixed to each other by adhesives or other means of attachment.

Casing 200, which is readily seen in FIGS. 5A and 5C to have an opening 250 through its center, is pushed over a teat cup (not shown) until it is brought near the top of the cup. Because of the inward inclination of crown 220 and the resilient, flexible material from which the crown 220 is made, crown 220 exerts pressure on the teat cup holding it in a fixed position on casing 210. The litz wire which serves as the antenna is encased therein and is therefore also held in a fixed position on the teat cup. The teat cup may be made of plastic, typically a transparent plastic, or of a non-magnetic metal, such as stainless steel.

The wire coil antenna is received in hollow 240 and contains multiple windings, 14 windings being a typical, but non-limiting, number. The diameter of the wire turnings is approximately the diameter of body 210 and typically is from about 4.5 to about 5.5 cm (˜2″).

In the present invention, particularly intended for small ruminants, typically, but without being limiting, sheep and goats, the antenna should have a range of about 10 to about 15 cm, preferably about 15 cm (˜6″). This is a large enough range to pick up the identification signal of the animal being milked but small enough not to receive interfering signals from other animals in the group waiting to be milked.

In yet other constructions, the wire coil antenna can be injection molded directly into a plastic teat cup during manufacture. The wire is protected from contact with water by the plastic. In such constructions, the antenna typically is positioned on the external side of the cup and does not interfere with the shape of the cup's interior. The wire coil can be positioned toward the top or bottom of the cup as required to minimize problems in handling the cup. The ends of the litz wire must protrude from the teat cup so that they can connect to a coaxial cable, such as cable 44 in FIGS. 1-3. Cable 44 leads to a stationary interrogation unit containing a transmitter/receiver controlled by a microprocessor.

In still other configurations, an encased litz wire coil can be attached by an attachment means such as an adhesive, an elastic band, a spring clip or the like, to the outside of the teat cup.

In other configurations, the antenna can be a small cylindrical ferrite antenna similar to ones used in transistor radios. Again it can be joined to the outside of the teat cup by an attachment means such as an adhesive, an elastic band, a spring clip or the like.

In yet other constructions the litz wire comprising the antenna can be wound around the outside of the teat cup forming a single layer, the cylindrically-shaped antenna having a typical diameter of about 1.5-2.0 cm and extending along the greater part of the length of the teat cup, typically 4 cm. In cases like the latter, the litz wire antenna should be protected by a water-proof material such as flexible plastic sheeting. Other waterproof materials could of course also be used.

While in the discussion herein, the wire used for the antenna has been described as litz wire, this is not to be considered limiting. Although litz wire is preferable, any other wire known to one skilled in the art can be used in place of litz wire.

In the above discussion, we have called the transmission source attached to the ruminant a transponder. A transponder generally receives energy from a transmitter located in the stationary interrogation unit by way of an antenna, here located on the teat cup. The transponder receives the energy and uses it to transmit an identification data signal, which identifies the animal to which the transponder is attached. The pulsed energy provided by the transmitter is controlled by a microprocessor.

In addition, even if the transponder does not require a pulse of energy from the transmitter in the stationary interrogation unit to transmit the identification data signal as discussed below, the transponder still requires a triggering signal from the stationary interrogation unit in order to initiate transmission of the identification data signal. The triggering signal reaches the transponder only when it is in proximity of the antenna attached to the teat cup. The antenna as described above is connected to, and in electrical communication with, the stationary interrogation unit.

Transponders exist which are battery operated and do not require a pulse of energy from the stationary interrogation unit to operate. However, they still require a triggering signal.

With the above in mind, it should be remembered that in lieu of a transponder, a battery operated, or other power source operated, transmitter can be attached to the hind part of the ruminant and can broadcast continuously or intermittently. However, only when the transmitter is in proximity to the antenna on the teat cup will the receiver in the stationary interrogation unit receive the identification data signal and transfer the information on to a microprocessor. In such cases, the stationary interrogation unit need only include a receiver.

The embodiment described in the immediate paragraph above, as well as other similar embodiments, where a transmitter, which is not a transponder, is used is contemplated as being within the teachings of this invention.

It will be appreciated by persons skilled in the art that the present invention is not limited by what has been particularly shown and described herein above. Rather the scope of the invention is defined by the claims that follow:

1. A system for identifying a ruminant being milked, said system including:
a transmitter attached to a hind part of the ruminant and operable to transmit a predefined signal identifying the ruminant to which said transmitter is attached; and
at least one teat cup positionable on a teat of the ruminant being milked and having an antenna affixed thereto, said antenna operable to receive the predefined signal and to provide the signal via a receiver device to a processor for interpreting the predefined signal thereby identifying the ruminant being milked.

2. A system according to claim 1 wherein said transmitter is adapted for attachment to a hind leg of the ruminant.

3. A system according to claim 2 wherein said transmitter is attachable to the hind leg by a strap.

4. A system according to claim 3 wherein said strap is an elastic strap.

5. A system according to claim 2 wherein said transmitter is part of a tag, said tag attachable to the hind leg.

6. A system according to claim 5 wherein said tag is an electronic ear tag.

7. A system according to claim 1 wherein said transmitter is adapted for attachment above the hock of a hind leg of the ruminant.

8. A system according to claim 1 wherein said transmitter is a transponder.

9. A system according to claim 8 wherein said system further includes a stationary interrogation unit, said unit including a transmitter and a receiver.

10. A system according to claim 8 wherein said transponder is adapted for attachment to a hind leg of the ruminant.

11. A system according to claim 10 wherein said transponder is attachable to the hind leg by a strap.

12. A system according to claim 11 wherein said strap is an elastic strap.

13. A system according to claim 10 wherein said transponder is part of a tag, said tag attachable to the hind leg.

14. A system according to claim 13 wherein said tag is an electronic ear tag.

15. A system according to claim 8 wherein said transponder is adapted for attachment above the hock of a hind leg of the ruminant.

16. A teat cup for positioning on a teat of a ruminant during milking, said teat cup including:
a flow-through vessel for collecting milk from the ruminant; and
an antenna affixed to said vessel to receive a signal that identifies the animal on which the teat cup is positioned.

17. A teat cup according to claim 16 further including a casing for enclosing said antenna and holding it to said teat cup.

18. A teat cup according to claim 17 wherein said casing is constructed of a flexible waterproof material.

19. A teat cup according to claim 16 wherein said teat cup is constructed of plastic material and said antenna is encased in said plastic material during the process of manufacture of said teat cup.

20. A method for identifying a ruminant, said method including the steps of:
attaching a means for collecting milk to a teat of a ruminant, the means for collecting milk having an antenna affixed thereto;
affixing a transmitter to a hind part of the ruminant, the transmitter transmitting a predefined signal identifying the ruminant;
receiving the transmitted predefined signal by the antenna; and
transferring the predefined signal via a receiver device to a processor which processes the signal and identifies the ruminant on which the means for collecting milk is attached.

21. A method according to claim 20 wherein said affixing step is a step of affixing a transponder.

22. A method according to claim 20 wherein said affixing step is effected by affixing the transmitter to a hind leg of the ruminant.

23. A method according to claim 22 wherein said affixing step is effected by affixing the transmitter to a hind leg of the ruminant using a strap.

24. A method according to claim 23 wherein said affixing step is effected by affixing the transmitter to a hind leg of the ruminant using an elastic strap.

25. A method according to claim 22 wherein said affixing step is effected by affixing the transmitter to a hind leg of the ruminant above the hock.

26. A method according to claim 20 wherein said affixing step is effected by affixing the transmitter as part of a tag attachable to a hind leg of the ruminant.
